(19) United States
(12) Patent Application Publication
(10) Pub. No.: US 2014/0093725 A1
(43) Pub. Date: Apr. 3, 2014

(54) Digital Overlaminate Films

(71) Applicant: Avery Dennison Corporation, (US)

(72) Inventors: Vadim ZAIKOV, Perry, OH (US); Chad CUMMINGS, Reminderville, OH (US); Wen-Li A. CHEN, Rochester, NY (US)

(73) Assignee: AVERY DENNISON CORPORATION, Pasadena, CA (US)

(21) Appl. No.: 13/739,602

(22) Filed: Jan. 11, 2013

Related U.S. Application Data
(60) Provisional application No. 61/585,406, filed on Jan. 11, 2012.

(51) Int. Cl. B32B 27/08; B32B 27/32; B32B 27/30

(52) U.S. Cl. CPC B32B 27/08; B32B 27/306; B32B 27/32
USPC 428/354; 428/523; 428/516

(57) ABSTRACT

The present subject matter relates to a non-PVC film and film laminate for use in marketing or advertising campaigns, for indoor or outdoor use, or other environment impacted promotions and safety applications. One embodiment of the film includes three layers. The top layer may include a homopolypropylene or a polypropylene/polyethylene random copolymer, with an optional gloss modifier. The film may be transparent, translucent, clear or have other desirable optical properties.

### CROSS REFERENCE TO RELATED APPLICATIONS

The present application claims the benefit of U.S. Provisional Application No. 61/585,406 filed Jan. 11, 2012, which is incorporated herein by reference in its entirety.

### FIELD

The present subject matter relates to PVC films and non-PVC film laminates for use with small format, and large format graphic films and presentations, advertising media, promotional media, static visual communications, and other commercial applications. The films are clear or transparent, or have other desirable optical properties.

### BACKGROUND

Polyvinyl chloride (PVC) films have been used widely in a number of promotional and advertising campaigns, such as outdoor and indoor graphics applications in the past. Such applications include signs, banners, fleet marketing graphics, architectural and wall covering, consumer product labeling and other pressure sensitive products. However, there is an increasing awareness concerning the environmental and health impacts and effects of using PVC based products, which has increased significantly in recent years. Currently, there is a movement to reduce or even eliminate PVC based products from the consumer marketing, promotional and advertising product streams.

Films for outdoor marketing and graphics applications ideally should have at least some of the following properties: printability, durability, color retention, and scratch resistance. Conformability and proper mechanical properties such as tensile elongation and tensile strength are also preferable for the application process. A non-conformable film, i.e. a film which does not have sufficient elongation or does not retain an elongated or deformed shape when so arranged, may not follow the contour of the subject or surface to which it is applied, and may create bubbles or gaps between the surface and the film. Insufficient conformability properties may make the film difficult to apply over a surface, e.g. those surfaces that have curves, angles, ridges and other non-planar configurations, but too much elongation may deform the film and potentially cause a distortion of the printed indicia. Films with a low tensile strength may cause the film to break easily when being stretched such as when the film is being applied to a non-planar surface.

As new PVC replacement films are being developed, some of the films have superior performance in one area, but may lack adequate functionality with respect to other properties, such as their outdoor durability to make the films unacceptable for the demanding advertising and promotional market. One possible way to resolve the foregoing problem is to use a multi-layer film laminate with each layer providing one or more of the desired properties so that the laminate has all the desired properties that are needed.

When used as the outermost protective layer in a film laminate, or simply used as a protective film for a given surface, good outdoor durability and in many cases optical transparency is also required so the indicia on an underneath printable layer can be visible. Therefore, there is a need for non-PVC based transparent films and non-PVC film laminates for use with outdoor graphics and other marketing and consumer use applications.

A variety of abbreviations will be used in this document: HPP—Homopolypropylene; HPPn—Homopolypropylene Nucleated; PE—Polyethylene; PP—Polypropylene; RCP—Random Copolymer; RCPn—Random Copolymer Nucleated; LDPE—Low Density Polyethylene; LLDPE—Linear Low Density Polyethylene, UV—Ultraviolet Absorber; FR—Flame Retardant; AB—Antiblock Agent; EVA—Ethyl-Vinyl Acetate RCP; FHR—Flint Hills Resources; HALS—Hindered amine light stabilizers; MFI—Melt Flow Index; MI—Melt Index; MFR—Melt Flow Rate.

### BRIEF SUMMARY

The embodiments of the present subject matter described below are not intended to be exhaustive or to limit the subject matter to the precise forms disclosed in the following detailed description. Rather, the embodiments are chosen and described so that others skilled in the art may appreciate and understand the principles and practices of the present subject matter.

The subject matter is directed to a non-PVC based film product having similar properties to those of conventional PVC offerings that is suitable for use in connection with marketing promotions, graphics, branding campaigns and other printed or imaged communication based initiatives. However, it will be understood that the present subject matter also extends to films having one or more layers containing PVC.

In one aspect, the present subject matter provides an optically transparent protective film comprising: a) a top layer, b) a middle layer, substantially coextensive with, and adhered to, the top layer, and c) a bottom layer, substantially coextensive with, and adhered to, the middle layer. The top layer includes a polypropylene homopolymer or copolymer.

In another aspect, the present subject matter also provides a glossy optically transparent protective film comprising: a) a skin layer comprising: i) an abrasion resistant resin having a MFR of 4.2-12 and a MI of 0.1 to 12, and ii) at least one additive selected from the group consisting of process aids and antiblock agents. The film also comprises b) at least one tie layer comprising: i) ethylene vinyl acetate having a MI of 0.1-10, and ii) 0 to 5 wt % UV stabilizer. And, the film additionally comprises c) a core layer comprising: i) 3.2-5.5% polyethylene PP/PE RCP having a MFR of 5-12, and ii) 0 to 5 wt % UV stabilizer. The film also comprises d) an adhesive layer comprising: i) 3.2 to 5.5% ethylene PP/PE RCP having a MFR of 5-12, ii) 0 to 5% UV stabilizer, iii) 0.1-2% antiblock agent, and iv) 0 to 1% of a process aid.

In another aspect, the present subject matter provides a multilayer film comprising (i) an outer layer or skin layer which includes an abrasion resistant resin, (ii) a core layer which includes at least one of polyethylene PP/PE RCP and HPP, and (iii) an adhesive layer which includes ethylene PP/PE RCP.

In another aspect, the present subject matter also provides a vinyl-free optically transparent protective film comprising: a) a top layer comprising: i) 50-100 wt % of a HPP or a PP/PE RCP, ii) 0-50 wt % of a gloss modifier, iii) 0-10 wt % of a slip agent, iv) 0.1-2 wt % of an antiblock agent, and v) 0.1-1.5 wt % of a flame retardant, the amounts of (iii)-(v) based on 100% total of (i)+(ii). The film also comprises b) a middle layer, substantially coextensive with, and adhered to, the top layer, comprising: i) 90-100 wt % linear low density polyethylene (LLDPE), ii) 0-10 wt % of a second component selected from the group consisting of LLDPE, LDPE, PP/PE RCP, HPP, EVA, and combinations thereof, and iii) 0.1-1 wt % of flame retardant, the amounts of (iii) based on 100% total of (i)+(ii). And, the film also comprises c) a bottom layer, substantially coextensive with, and adhered to, the middle layer, comprising: i) 85-97 wt % of at least one agent selected from the group consisting of HPP, PP/PE RCP, LLDPE and LDPE, ii) 3-15 wt % of EVA with 18-35 wt % vinyl acetate, iii) 0.1-1.5 wt % of an antiblock agent, and iv) 0.1-1 wt % flame retardant additive, the amounts of (iii)-(iv) based on 100% total of (i)+(ii).

In still another aspect, the present subject matter provides a multilayer film assembly comprising: a) a polymeric top layer, b) a middle layer adjacent to and in contact with the top layer, and c) a bottom layer comprising a polyethylene PP/PE RCP.

In yet another aspect, the present subject matter also provides an optically transparent protective film comprising: a) a top layer comprising: i) 50-100 wt % of a HPP or a PP/PE RCP, ii) 0-50 wt % of a gloss modifier, iii) 0-10 wt % of a slip agent, iv) 0.1-2 wt % of an antiblock agent, and v) 0.1-1.5 wt % of a flame retardant, the amounts of (iii)-(v) based on 100% total of (i)+(ii). The film also comprises b) a middle layer, substantially coextensive with, and adhered to, the top layer, comprising: i) 90-100 wt % of a first resin selected from the group consisting of LLDPE, PP/PE RCP, HPP, EVA, and combinations thereof, ii) 0-10 wt % of a second resin, different from the first resin, selected from the group consisting of LLDPE, LDPE, PP/PE RCP, HPP, EVA, and combinations thereof, iii) 0.1-1 wt % of flame retardant, the amounts of (iii) based on 100% total of (i)+(ii). And, the film also comprises c) a bottom layer, substantially coextensive with, and adhered to, the middle layer, comprising: i) 85-99.9 wt % of at least one agent selected from the group consisting of HPP, PP/PE RCP, LLDPE, LDPE, and combinations thereof, ii) 0.1-15 wt % of EVA with 18-35 wt % vinyl acetate, iii) 0.1-1.5 wt % of an antiblock agent, and iv) 0.1-1 wt % flame retardant additive, the amounts of (iii)-(iv) based on 100% total of (i)+(ii).

In still another aspect, the present subject matter also provides a protective film comprising: a) a top layer comprising: i) 80-100 wt % of HPP or PP/PE RCP, ii) 0-20 wt % of gloss modifier, iii) 1-5 wt % of a slip agent, iv) 0.1-1 wt % antiblock agent, and v) 0.1-1 wt % flame retardant, the amounts of (iii)-(v) based on 100% total of (i)-(ii). The film also comprises b) a middle layer comprising: i) 95-100 wt % of a first resin selected from the group consisting of LLDPE, PP/PE RCP, and combinations thereof, ii) 0-5 wt % of the second resin, different from the first resin, selected from the group consisting of LLDPE, LDPE, PP/PE RCP, HPP, EVA, and combinations thereof, and iii) 0.1-1 wt % of flame retardant, the amount of (iii) based on 100% total of (i)+(ii). The film also comprises c) a bottom layer comprising: i) 85-99.9 wt % of the at least one first resin, ii) 0.1-15 wt % of EVA copolymer, iii) 0.5-1.5 wt % of an antiblock agent, and iv) 0.1-1 wt % of flame retardant, the amounts of (iii)-(iv) based on 100% total of (i)+(ii).

Other features and advantages of the present subject matter will become apparent to those skilled in the art from the following detailed description. It is to be understood, however, that the detailed description of the various embodiments and specific examples, while indicating preferred and other embodiments of the present subject matter, are given by way of illustration and not limitation. Many changes and modifications within the scope of the present subject matter may be made without departing from the spirit thereof, and the subject matter includes all such modifications.

### BRIEF DESCRIPTION OF THE DRAWINGS

These, as well as other objects and advantages of this subject matter, will be more completely understood and appreciated by referring to the following more detailed description of the presently preferred embodiments of the subject matter in conjunction with the accompanying drawings, of which:

FIG. 1 is a sectional illustration of one embodiment of a three-layer film according to the present subject matter; including top layer 110, core layer 120 and adhesive layer 130.

FIG. 2 is a sectional illustration of one embodiment of a four-layer film according to the present subject matter; including top layer 210 tied to core layer 220 with tie layer 240, and adhesive layer 230.

FIG. 3 depicts the application of a construct of the subject matter to a printed film.

Unless otherwise indicated, the illustrations in the noted figures are not necessarily drawn to scale.

### DETAILED DESCRIPTION

The compositions, articles and methods disclosed herein are described by way of examples and with reference to the figures. Unless otherwise specified, like numbers in the figures indicate references to the same, similar, or corresponding elements throughout the figures. It will be appreciated that modifications to disclosed and described examples, arrangements, configurations, components, elements, apparatuses, methods, materials, etc. can be made and may be desired for a specific application. In this disclosure, any identification of specific shapes, materials, techniques, arrangements, etc. are either related to a specific example presented or are merely a general description of such a shape, material, technique, arrangement, etc. Identifications of specific details or examples are not intended to be, and should not be, construed as mandatory or limiting unless specifically designated as such. Selected examples of compositions, articles and methods are hereinafter disclosed and described in detail with reference made to various figures.

The present subject matter relates to a film and a film laminate used for indoor and outdoor graphics applications, advertising, promotions and other marketing campaigns. More particularly, the present subject matter relates to a non-PVC transparent film and non-PVC film laminate for use in such applications. The film and film laminate provide suitable outdoor durability, scratch resistance, gloss, conformability, tensile elongation and tensile strength.

In many of the films and film assemblies described herein, one or more layers are free of PVC or substantially free of PVC. This aspect is referred to as the layer(s) substantially lacking PVC.

Broadly, the film has three layers, but in certain embodiments may have four or more layers. A fourth layer (tie layer) may be used in applications utilizing resins having differing chemistries, and particularly when resins having differing chemistries are used in the top and/or core layers. An example of this is when a tie layer is used between, and to bond, Surlyn® in a top layer with a core layer.

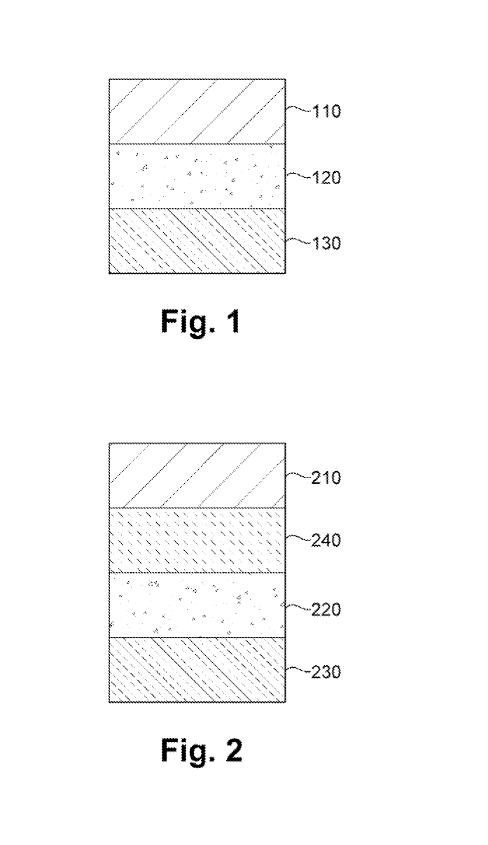

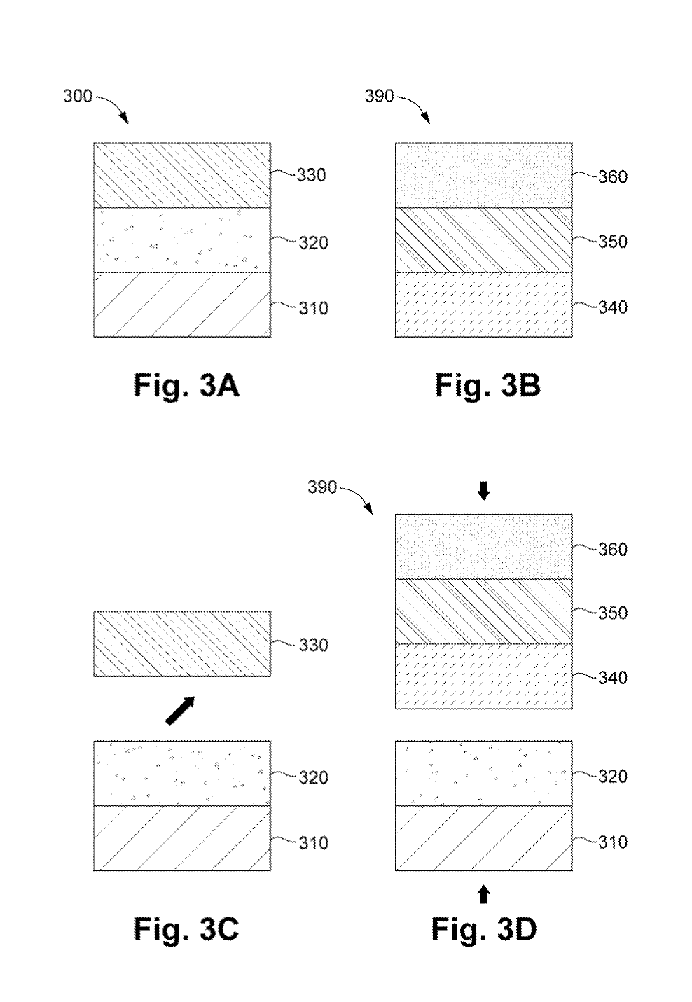

The three- or four-layer constructions are used to protect printed indicia, graphics, printed materials and the like. FIG. 1 depicts one embodiment of a three-layer film according to the present subject matter; including top layer 110, core layer 120 and adhesive layer 130. FIG. 2 depicts a four-layer film according to the present subject matter; including top layer 210 tied to core layer 220 with tie layer 240, and adhesive layer 230.

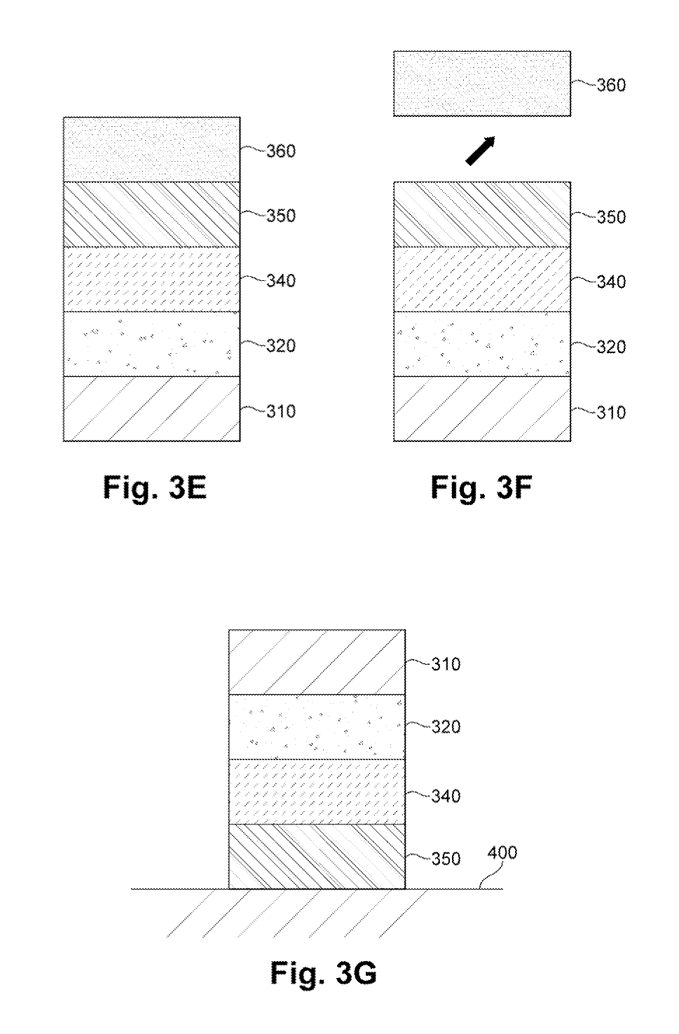

The various constructions are used as follows. A printed film construction having an adhesive and release liner is joined to a construct of the subject matter. In FIG. 3A, a construct of the subject matter 300, including release liner 330, adhesive 320, and overlaminate film 310 is provided. In FIG. 3B, a printed film construction 390, including release liner 360, adhesive 350, and print film 340 is provided. In FIG. 3C, the release liner 330 of the noted construct is separated. In FIG. 3D, the resulting adhesive 320/overlaminate film 310 of the subject matter is applied over the release liner 360/adhesive 350/printed film 340 construction over the printed image to form the five-layer structure of FIG. 3E. Finally, in FIG. 3F, the remaining release liner 360 (that from the printed film construction) is removed, and the entire sandwich of two multilayer films (350/340/320/310) is applied onto a substrate 400, as shown in FIG. 3G.

Generally, the multilayer films of the present subject matter comprise random copolymers of polypropylene and/or polyethylene which are referred to herein as PP/PE RCP. In certain embodiments, the PP/PE RCP includes particular proportions of polyethylene such as 1-10% or more, in other embodiments about 3% to about 6%, and more particularly from about 3.2% to about 5.5%. In certain versions of the present subject matter, 3.2% polyethylene PP/PE RCP is utilized.

In certain versions of the subject matter, a multi-layer transparent film provides properties suitable for use in outdoor graphics applications. The multi-layer film has at least three layers. The first layer comprises abrasion resistant resins, optional gloss modifiers when a matte finish is desired, PP/PE RCP, and/or HPPs, (the latter two of which may be nucleated). The thickness of this first layer can be from about 0.3 mil (7.6 microns) to about 2 mils (50.8 microns). Examples of suitable polymers in the first, or “top” layer include, as an abrasion resistant resin, DuPont Surlyn® 9120 or Flint Hills Resources P4G3Z-050F; as gloss modifier, Ampacet 400700-D, POLYBATCH® DUL 3636 DP20 from A. Schulman; as a HPP, Dow D218.00; as a PP/PE RCP, Dow DS6D81 or Flint Hills Resources 43S2A; as a nucleated homopolymer, Flint Hills Resources P4G4K-205×; as a nucleated PP/PE RCP, Flint Hills Resources P5C4K-089×. When a gloss modifier is used, it may be present in an amount up to 50 wt %, the balance being HPP or PP/PE RCP in the amount of 50-100 wt %. In other embodiments, the HPP or PP/PE RCP may be present at 75-100 wt % and the gloss modifier at 0-25 wt %.

The other layers provide additional mechanical strength, improved adhesion, improved conformability and reduced cost to the overall construction. The number of layers can be determined based on the final requirement on the product, the cost restriction and availability of processing equipments. Such other layers can be made largely from the same polymers making up the first layer, however, with some differences. The other layers include the core and adhesive layers, which may alternately be termed middle and bottom layers. The core and adhesive layers may include in addition to the polypropylene/polyethylene random copolymers (PP/PE RCP), and/or homopolypropylenes (HPP) of the top layer, linear low density polyethylene (LLDPE), low density polyethylene (LDPE), and ethylene vinyl acetate (EVA).

When ethylene vinyl acetate is used, typically a suitable grade is utilized having 18-35% vinyl acetate content. It will be appreciated that the present subject matter includes the use of other grades and types of EVA, such as EVA copolymers.

The adhesive, or bottom, layer may include any polymer used in the core layer, that is, PP/PE RCP, and/or HPPs of the top layer, LLDPE, LDPE, and EVA. The thickness of such other layers can vary from about 0.2 mil to about 2 mils. Examples of suitable resins include, as LLDPE, Dow Dowlex® 2056G; as LDPE, NA 952-000 (MI=2.0) from Equistar; PE1017 (MI=2.0) from Huntsman; and AT 525 (MI=0.8) from Celanese, and as EVA, Celanese Ateva® 1821A.

In one embodiment of the subject matter, a non-PVC film, which may be clear, transparent, translucent, or have other desirable optical properties, is a protective film comprising: (a) a top layer, (b) a middle layer, substantially coextensive with, and adhered to, the top layer, and (c) a bottom layer, substantially coextensive with, and adhered to, the middle layer, wherein the top layer includes a polypropylene homopolymer or copolymer and an optional gloss modifier. Each layer may be present in a weight percentage amount relative to the entire film. For example, the layers may be present in a weight ratio of 5-15 wt % top/70-90 wt % middle/5-15 wt % bottom, or broadly 5-25 wt % top/50-90 wt % middle/5-25 wt % bottom.

Another embodiment of the subject matter is a glossy protective film comprising: (a) a skin layer comprising: (i) an abrasion resistant resin, (ii) at least one additive selected from the group consisting of HALS, process aids and antiblock agents, (b) at least one tie layer comprising: (i) EVA, and (ii) a HALS, (c) a core layer comprising: (i) 3.2-5.5% ethylene PP/PE RCP and (ii) a UV stabilizer, and (d) an adhesive layer comprising (i) PP/PE RCP, (ii) EVA, and (iii) at least one additive selected from the group consisting of UV stabilizers, process aids and antiblock agents. The layers may be present in a weight ratio of 5-15 wt % skin/5-15 wt % tie/50-70 wt % core and adhesive.

Another embodiment of the subject matter is a glossy protective film comprising: (a) a skin layer comprising: (i) up to 100 wt % of an ethylene/methacrylic copolymer (zinc ionomer) resin (exemplified by Surlyn® 9120), (ii) optionally, at least one additive selected from the group consisting of UV stabilizers, process aids and antiblock agents, (b) at least one tie layer comprising: (i) EVA and (ii) UV stabilizer, (c) a core layer comprising: (i) 3.2-5.5% PP/PE RCP and (ii) a UV stabilizer, and (d) an adhesive layer comprising (i) PP/PE RCP, (ii) EVA, and (iii) at least one additive selected from the group consisting of UV stabilizers, process aids and antiblock agents. The layers may be present in a weight ratio of 5-15 wt % top skin/5-15 wt % tie/55-85 wt % core/5-15 wt % adhesive.

In another embodiment of the subject matter, a matte optically transparent protective film comprises: (a) an outer layer comprising: (i) an abrasion resistant resin, (ii) a gloss modifier, (iii) at least one additive selected from the group consisting of HALS, process aids and antiblock agents, (b) a core layer comprising: (i) 3.2-5.5% ethylene PP/PE RCP, and (ii) a HALS, and (c) an adhesive layer comprising: (i) 3.2-5.5% ethylene PP/PE RCP, (ii) EVA, (iii) a UV stabilizer, (iv) a process aid, and (v) an antiblock agent. The layers may be present in a weight ratio of 5-15 wt % outer/70-90 wt % core/5-15 wt % adhesive.

Another embodiment of the subject matter is a glossy optically transparent protective film comprising: (a) a skin layer comprising: (i) an abrasion resistant resin, (ii) at least one additive selected from the group consisting of HALS, process aids and antiblock agents, (b) a tie layer comprising: (i) EVA, and (ii) a HALS, (c) a core layer comprising: (i) 3.2-5.5% ethylene PP/PE RCP and (ii) a UV stabilizer, and (d) an adhesive layer comprising: (i) 3.2-5.5% ethylene PP/PE RCP, (ii) EVA, (iii) a UV stabilizer, (iv) a process aid, and (v) an antiblock agent. The layers may be present in a weight ratio of 5-15 wt % skin:5-15 wt % tie:55-85 wt % core:5-15 wt % adhesive.

Yet another embodiment of the subject matter is a glossy optically transparent protective film comprising: (a) an outer layer comprising: (i) an abrasion resistant resin, (ii) at least one additive selected from the group consisting of HALS, process aids and antiblock agents, (b) a core layer comprising: (i) PP/PE RCP, (ii) a HALS, and (c) an adhesive layer comprising: (i) 3.2-5.5% ethylene PP/PE RCP, (ii) EVA, (iii) a UV stabilizer, (iv) an antiblock agent, and (v) a process aid.

Another embodiment of the subject matter is a matte optically transparent protective film comprising: (a) an outer layer comprising: (i) an abrasion resistant resin, (ii) a gloss modifier, (iii) a HALS, and (iv) a process aid, (b) a core layer comprising: (i) HPP, and (ii) a HALS, and (c) an adhesive layer comprising: (i) PP/PE RCP, (ii) EVA, (iii) a UV stabilizer, (iv) a process aid, and (v) an antiblock agent.

Another embodiment of the subject matter is a vinyl-free optically transparent protective film comprising: (a) a top layer comprising: (i) 50-100 wt % of a HPP or a PP/PE RCP, (ii) 0-50 wt % of a gloss modifier, (iii) 0-10 wt % of a slip agent, (iv) 1-5 wt % of a HALS, (v) 0.1-2 wt % of an antiblock agent, and (vi) 0.1-1.5 wt % of a flame retardant, the amounts of (iii)-(vi) based on 100% total of (i)+(ii); (b) a middle layer, substantially coextensive with, and adhered to, the top layer, comprising: (i) 90-100 wt % LLDPE, (ii) 0-10 wt % of a second component selected from the group consisting of LLDPE, LDPE, PP/PE RCP, HPP, EVA, and combinations thereof, (iii) 0.5-3 wt % HALS, (iv) 0.1-1 wt % of flame retardant, the amounts of (iii)-(iv) based on 100% total of (i)+(ii); (c) a bottom layer, substantially coextensive with, and adhered to, the middle layer, comprising: (i) 85-97 wt % of at least one agent selected from the group consisting of HPP, PP/PE RCP, LLDPE and LDPE, (ii) 3-15 wt % of EVA with 18-35 wt % vinyl acetate, (iii) 0.1-1.5 wt % of an antiblock agent, and (iv) 0.1-1 wt % flame retardant additive, the amounts of (iii)-(iv) based on 100% total of (i)+(ii).

Still another embodiment of the subject matter is a vinyl-free optically transparent protective film comprising: (a) a top layer comprising: (i) 50-100 wt % of a HPP or a PP/PE RCP, (ii) 0-50 wt % of a gloss modifier, (iii) 0-10 wt % of a slip agent, (iv)1-5 wt % of a HALS, (v) 0.1-2 wt % of an antiblock agent, and (vi) 0.1-1.5 wt % of a flame retardant, the amounts of (iii)-(vi) based on 100% total of (i)+(ii); (b) a middle layer, substantially coextensive with, and adhered to, the top layer, comprising: (i) 90-100 wt % of a first resin selected from the group consisting of LLDPE, PP/PE RCP, HPP, EVA, and combinations thereof, (ii) 0-10 wt % of a second resin, different from the first resin, selected from the group consisting of LLDPE, LDPE, PP/PE RCP, HPP, EVA, and combinations thereof, (iii) 0.5-3 wt % HALS, (iv) 0.1-1 wt % of flame retardant, the amounts of (iii)-(iv) based on 100% total of (i)+(ii); (c) a bottom layer, substantially coextensive with, and adhered to, the middle layer, comprising: (i) 85-99.9 wt % of at least one agent selected from the group consisting of HPP, PP/PE RCP, LLDPE and LDPE, (ii) 0.1-15 wt % of EVA with 18-35 wt % vinyl acetate, (iii) 0.1-1.5 wt % of an antiblock agent, and (iv) 0.1-1 wt % flame retardant additive, the amounts of (iii)-(iv) based on 100% total of (i)+(ii).

In another embodiment of the subject matter, a non-PVC film, which may be clear, transparent, translucent, or have other desirable optical properties, is a protective film comprising: (a) a top layer, (b) a middle layer, substantially coextensive with, and adhered to, the top layer, and (c) a bottom layer, substantially coextensive with, and adhered to, the middle layer, wherein the top layer includes a polypropylene homopolymer or copolymer.

Another embodiment of the subject matter is a glossy protective film comprising: (a) a skin layer comprising: (i) an abrasion resistant resin, (ii) at least one additive selected from the group consisting of HALS, process aids and antiblock agents, (b) at least one tie layer comprising: (i) at least one agent selected from the group consisting of HPP, PP/PE RCP, LLDPE, LDPE, or combinations thereof, optionally including ethylene vinyl acetate, (ii) a HALS, and (iii) an antiblock agent, and (c) a core layer comprising: (i) 3.2% PP/PE random copolymer and (ii) a UV stabilizer, and (d) an adhesive layer comprising: (i) PP/PE RCP, (ii) EVA, (iii) a UV stabilizer, (iv) a process aid, and (v) an antiblock agent.

In another embodiment of the subject matter, a matte optically transparent protective film comprises: (a) an outer layer comprising: (i) an abrasion resistant resin, (ii) a gloss modifier, (iii) at least one additive selected from the group consisting of HALS, process aid and antiblock agent, (b) a core layer comprising: (i) PP/PE RCP, and (ii) a HALS, and (c) an adhesive layer comprising: (i) PP/PE RCP, (ii) EVA, (iii) a UV stabilizer, (iv) a process aid, and (v) an antiblock agent.

Another embodiment of the subject matter is a glossy optically transparent protective film comprising: (a) a skin layer comprising: (i) an abrasion resistant resin, (ii) at least one additive selected from the group consisting of HALS, process aids and antiblock agents, (b) a tie layer comprising: (i) ethylene vinyl acetate, (ii) a HALS, and (iii) a flame retardant; (c) a core layer comprising: (i) PP/PE RCP and (ii) a UV stabilizer, and (c) an adhesive layer comprising: (i) PP/PE RCP, (ii) EVA, (iii) a UV stabilizer, (iv) a process aid, and (v) an antiblock agent.

Yet another embodiment of the subject matter is a glossy optically transparent protective film comprising: (a) an outer layer comprising: (i) an abrasion resistant resin, (ii) at least one additive selected from the group consisting of HALS, process aids and antiblock agents, (b) a core layer comprising: (i) PP/PE RCP, (ii) a HALS, and (c) an adhesive layer comprising: (i) ethylene PP/PE RCP, (ii) EVA, (iii) a UV stabilizer, (iv) an antiblock agent, and (v) a process aid.

Another embodiment of the subject matter is a matte optically transparent protective film comprising: (a) an outer layer comprising: (i) an abrasion resistant resin, (ii) a gloss modifier, (iii) a HALS, and (iv) a process aid, (b) a core layer comprising: (i) HPP, and (ii) a HALS, and (c) an adhesive layer comprising: (i) PP/PE RCP, (ii) EVA, (iii) a UV stabilizer, (iv) a process aid, and (v) an antiblock agent.

Another embodiment of the subject matter is a vinyl-free optically transparent protective film comprising: (a) a top layer comprising: (i) 50-100 wt % of a HPP or a PP/PE RCP, (ii) 0-50 wt % of a gloss modifier, (iii) 0-10 wt % of a slip agent, (iv) 1-5 wt % of a HALS, (v) 0.1-2 wt % of an antiblock agent, and (vi) 0.1-1.5 wt % of a flame retardant, the amounts of (iii)-(vi) based on 100% total of (i)+(ii); (b) a middle layer, substantially coextensive with, and adhered to, the top layer, comprising: (i) 90-100 wt % linear low density polyethylene, (ii) 0-10 wt % of a second component selected from the group consisting of LLDPE, LDPE, PP/PE RCP, HPP, EVA, and combinations thereof, (iii) 0.5-3 wt % HALS, (iv) 0.1-1 wt % of flame retardant, the amounts of (iii)-(iv) based on 100% total of (i)+(ii); (c) a bottom layer, substantially coextensive with, and adhered to, the middle layer, comprising: (i) 85-97 wt % of at least one agent selected from the group consisting of HPP, PP/PE RCP, LLDPE and LDPE, (ii) 3-15 wt % of ethylene vinyl acetate with 18-35 wt % vinyl acetate, (iii) 0.1-1.5 wt % of an antiblock agent, and (iv) 0.1-1 wt % flame retardant additive, the amounts of (iii)-(iv) based on 100% total of (i)+(ii).

Still another embodiment of the subject matter is a vinyl-free optically transparent protective film comprising: (a) a top layer comprising: (i) 50-100 wt % of a HPP or a PP/PE RCP, (ii) 0-50 wt % of a gloss modifier, (iii) 0-10 wt % of a slip agent, (iv)1-5 wt % of a HALS, (v) 0.1-2 wt % of an antiblock agent, and (vi) 0.1-1.5 wt % of a flame retardant, the amounts of (iii)-(vi) based on 100% total of (i)+(ii); (b) a middle layer, substantially coextensive with, and adhered to, the top layer, comprising: (i) 90-100 wt % of a first resin selected from the group consisting of LLDPE, PP/PE RCP, HPP, EVA, and combinations thereof, (ii) 0-10 wt % of a second resin, different from the first, selected from the group consisting of LLDPE, LDPE, PP/PE RCP, HPP, EVA, and combinations thereof, (iii) 0.5-3 wt % HALS, (iv) 0.1-1 wt % of flame retardant, the amounts of (iii)-(iv) based on 100% total of (i)+(ii); (c) a bottom layer, substantially coextensive with, and adhered to, the middle layer, comprising: (i) 85-99.9 wt % of at least one agent selected from the group consisting of HPP, PP/PE RCP, LLDPE and LDPE, (ii) 0.1-15 wt % of ethylene vinyl acetate with 18-35 wt % vinyl acetate, (iii) 0.1-1.5 wt % of an antiblock agent, and (iv) 0.1-1 wt % flame retardant additive, the amounts of (iii)-(iv) based on 100% total of (i)+(ii).

### Examples

The following exemplary formulations represent non-limiting embodiments of the subject matter and are set forth in Tables 1-8.

Amounts of resins total 100 wt %, while amounts of additives are measured as parts per hundred (typically of rubber). Generally, an entry that spans two or more lines means that any or all of the components may be present in any amounts totaling the value in question. For example, the entry “50” that spans the components 400700-D and DUL 3636 DP20 in Table 1 for a matte finish in the top layer means that 400700-D and DUL 3636 DP20 may be present in any amounts so long as they total 50 wt % of the top layer. The exception is for the adhesive layer, where only one of the four resins (in Table 1) can be used but not blends thereof, indicated by “85 no blend.”

Many of the resins, materials, and/or polymers utilized in the films and film assemblies of the present subject matter exhibit particular ranges or values of melt flow index (MFI) and/or ranges or values of melt flow rate (MFR). For example, in certain versions of the present subject matter, ethylene vinyl acetate having a melt index (MI) of 0.1-10 is used. Certain grades of polyethylene can be used such as those having a melt flow rate (MFR) of 5-12. Certain grades of ethylene (or polyethylene) PP/PE RCP can be used such as those having a MFR of 5-12; and/or those having a MFI of 1-10. Certain EVA copolymers can be used such as those having a MFI of 2-4. Certain grades of polypropylene can be used such as those having a MFI of 3-12. Certain grades of gloss modifiers can be used such as those having a MFI of 2-4 or 2-5. And, in certain embodiments, the HPP or PP/PE RCF has a MFI of 4-15. It will be appreciated that the present subject matter is not limited to these particular materials.

TABLE 1
Embodiments Including Top, Core and Adhesive Layers.

| | | | | MFR/ | | | | | |
|---|---|---|---|---|---|---|---|---|---|
| Layer | Manufacturer | Manufacturer # | Chemistry | (MI) | Gloss | Matte | Gloss | Matte | Layer % |
| Top | Ampacet | 400700-D | Matif 97 | 3.0 | | 50 | | 50 | 10 |
| | A. Schulman | DUL 3636 DP20 | | n/a | | | | | |
| | Dow | Dow D218.00 | HPP | 8.0 | 100 | 50 | 100 | 50 | |
| | Dow | DS6D81 | PP/PE RCP | 5.0 | | | | | |
| | Flint Hills | P4G4K-205X | HPPn | 12 | | | | | |
| | Flint Hills | P5C4K-089X | RCPn | 10 | | | | | |

| A. Schulman | Sper-6 | Slip in HPP | 12 | up to 3.0 | |
|---|---|---|---|---|---|
| A. Schulman | SPER-6-SC | Slip in RCP | 11 | | |
| Ampacet | 404276 | UV in HPP | 12 | 2.5 | 2.0 |

| | | | | | |
|---|---|---|---|---|---|
| Ampacet | 401960 | AB in RCP | 9.0 | 0.5 | 0.5 |

| | Polyfil | FRC-2005PP | FR in HPP | 12 | 0.5 | | |
|---|---|---|---|---|---|---|---|
| Core | Dow | Dowlex 2056G | LLDPE | (1.0) | 100 | | 80 |
| | Dow | DS6D81 | PP/PE RCP | 5.0 | | | |
| | Dow | Dow D218.00 | HPP | 8.0 | | | |
| | Flint Hills | P4G4K-205X | HPPn | 12 | | | |
| | Flint Hills | P5C4K-089X | RCPn | 10 | | | |
| | Ampacet | 404276 | UV in HPP | 12 | 2.5 | 1.0 | |

| | | | | | | |
|---|---|---|---|---|---|---|
| | Polyfil | FRC-2005PP | FR in HPP | 12 | 0.5 | |
| Adhesive | Dow | Dow D218.00 | HPP | 8.0 | 85 (no blend) | 10 |
| | Flint Hills | P4G4K-205X | HPPn | 12 | | |
| | Flint Hills | P5C4K-089X | RCPn | 10 | | |
| | Dow | Dowlex 2056G | LLDPE | (1.0) | | |
| | Celanese | Ateva 1821A | EVA (18% VA) | (3.0) | 15 | |
| | Ampacet | 401960 | AB in RCP | 9.0 | 1.0 | |
| | Polyfil | FRC-2005PP | FR in HPP | 12 | 0.5 | |

TABLE 2
Intermediate Gloss and Intermediate Matte Formulations.

| | | | | | | | |
|---|---|---|---|---|---|---|---|
| | | | | | | | Cast- |
| Layers | Supplier | Supplier ID | Load, % | Purpose | Layer, % | Feedblock | MDO |

Intermediate-gloss

| | | | | | | | |
|---|---|---|---|---|---|---|---|
| Top skin | FHR | 43S2A | 95 | 3.2% PE PP/PE RCP | 10 | 3-layer | Cast |
| | A.Schulman | SPER-6-SC | 5.0 | Slip agent | | | |
| | Ampacet | 10561 | 2.5A | UV stabilizer in LDPE | | | |
| | Ampacet | 10919 | 0.5A | Process aid in LDPE | | | |
| | A.Schulman | AB-5 | 1.0A | Antiblock in LDPE | | | |
| Core | FHR | 43S2A | 100 | 3.2% PE PP/PE RCP | 80 | | |
| layer | Ampacet | 10561 | 2.5A | UV stabilizer in LDPE | | | |
| Adhesive | FHR | 43S2A | 85 | 3.2% PE PP/PE RCP | 10 | | |
| layer | Celanese | Ateva 1821A | 15 | EVA | | | |
| | Ampacet | 10561 | 2.5A | UV stabilizer in LDPE | | | |
| | Ampacet | 10919 | 0.5A | Process aid in LDPE | | | |
| | A.Schulman | AB-5 | 1.0A | Antiblock in LDPE | | | |

Intermediate-matte

| | | | | | | | |
|---|---|---|---|---|---|---|---|
| Top layer | FHR | P4G3Z-050F | 50 | Abrasion-resistant | 10 | 3-layer | Cast |
| | | | | resin | | | |
| | Ampacet | 400700-D | 50 | Gloss modifier | | | |
| | A.Schulman | DUL3636DP20 | | (either) | | | |
| | Ampacet | 10561 | 2.5A | UV stabilizer in LDPE | | | |
| | Ampacet | 10919 | 0.5A | Process aid in LDPE | | | |
| Core | FHR | 43S2A | 100 | 3.2% PE PP/PE RCP | 80 | | |
| layer | Ampacet | 10561 | 2.5A | UV stabilizer in LDPE | | | |
| Adhesive | FHR | 43S2A | 85 | 3.2% PE PP/PE RCP | 10 | | |
| layer | Celanese | Ateva 1821A | 15 | EVA | | | |
| | Ampacet | 10561 | 2.5A | UV stabilizer in LDPE | | | |
| | Ampacet | 10919 | 0.5A | Process aid in LDPE | | | |
| | A.Schulman | AB-5 | 1.0A | Antiblock in LDPE | | | |

TABLE 3
Promotional Gloss and Promotional Matte Formulations.

| | | | | | | | |
|---|---|---|---|---|---|---|---|
| | | | | | | | Cast- |
| Layers | Supplier | Supplier ID | Load, % | Purpose | Layer, % | Feedblock | MDO |

Promotional-gloss

| | | | | | | | |
|---|---|---|---|---|---|---|---|
| Top layer | FHR | 43S2A | 100 | 3.2% PE PP/PE RCP | 10 | 3-layer | MDO |
| | Ampacet | 10561 | 2.0A | UV stabilizer in LDPE | | | |
| | Ampacet | 401960 | 0.5A | Antiblock in RCP | | | |
| | Ampacet | 401198 | 0.5A | Process aid in HPP | | | |
| Core | FHR | 43S2A | 100 | 3.2% PE PP/PE RCP | 80 | | |
| layer | Ampacet | 10561 | 1.0A | UV stabilizer in LDPE | | | |
| Adhesive | FHR | 43S2A | 85 | 3.2% PE PP/PE RCP | 10 | | |
| layer | Celanese | Ateva 1821A | 15 | EVA | | | |
| | Ampacet | 10561 | 1.0A | UV stabilizer in LDPE | | | |
| | Ampacet | 401960 | 0.5A | Antiblock in RCP | | | |
| | Ampacet | 401198 | 0.5A | Process aid in HPP | | | |

Promotional-matte

| | | | | | | | |
|---|---|---|---|---|---|---|---|
| Top layer | FHR | P4G3Z-050F | 50 | Abrasion-resistant | 10 | 3-layer | Cast |
| | | | | resin | | | |
| | Ampacet | 400700-D | 50 | Gloss modifier (either) | | | |
| | A.Schulman | DUL3636DP20 | | | | | |
| | Ampacet | 10561 | 2.0A | UV stabilizer in LDPE | | | |
| | Ampacet | 401198 | 0.5A | Process aid in HPP | | | |
| Core | FHR | P4G3Z-050F | 50 | PP | 80 | | |
| layer | FHR | 43S2A | 50 | 3.2% PE PP/PE RCP | | | |
| | Ampacet | 10561 | 1.0A | UV stabilizer in LDPE | | | |
| Adhesive | FHR | 43S2A | 85 | 3.2% PE PP/PE RCP | 10 | | |
| layer | Celanese | Ateva 1821A | 15 | EVA | | | |
| | Ampacet | 10561 | 1.0A | UV stabilizer in LDPE | | | |
| | Ampacet | 401960 | 0.5A | Antiblock in RCP | | | |
| | Ampacet | 401198 | 0.5A | Process aid in HPP | | | |

TABLE 4
Alternate Intermediate Gloss formulation.

| | | Supplier | Load, | | Layer, |
|---|---|---|---|---|---|
| Layer | Supplier | ID | % | Purpose | % |
| Skins | DuPont | Surlyn | 100 | Abrasion-resistant | 10 |
| | | 9120 | | resin | |
| | Ampacet | 10561 | 2.5 A | UV stabilizer in LDPE | |
| | Ampacet | 10919 | 0.5 A | Process aid in LDPE | |
| | A. | AB-5 | 1.0 A | Antiblock in LDPE | |
| | Schulman | | | | |
| Tie | AT | Ateva | 100 | EVA | 10 |
| layers | Plastics | 1821A | | | |
| | Ampacet | 10561 | 2.5 A | UV stabilizer in LDPE | |
| Core | FHR | 43S2A | 100 | 3.2% PE PP/PE RCP | 70 |
| layer | Ampacet | 10561 | 2.5 A | UV stabilizer in LDPE | |
| Adhesive | FHR | 43S2A | 85 | 3.2% PE PP/PE RCP | 10 |
| layer | Celanese | Ateva | 15 | EVA | |
| | | 1821A | | | |
| | Ampacet | 10561 | 1.0 A | UV stabilizer in LDPE | |
| | Ampacet | 401960 | 0.5 A | Antiblock in RCP | |
| | Ampacet | 401198 | 0.5 A | Process aid in HPP | |

As used herein the term “graphic” or “graphics” refers to a visually perceptible presentation on a surface that is intended to brand, illustrate, entertain, inform, advertise, announce and market a product, service, event or the like.

In addition, the film layers may have at least one additive added to any of the layers. The additives are selected from a group including antiblock agents, UV stabilizing agents, free-radical scavengers, cross-linking agents, thickeners, flow and leveling agents, rheology modifiers, surfactants, defoamers, dispersants, wetting agents, or combinations thereof. Advantageously, the films of the subject matter are preferably free of N-methylpyrrolidone (NMP), a component typically used as a processing solvent in other applications. It is known that solvents are typically avoided in the processes of the subject matter. However, in certain limited applications the present subject matter includes the use of one or more solvents.

Hindered amine light stabilizers (HALS) are sufficient to prevent UV degradation in the films of the subject matter. Suitable commercially available HALS for the practice of the present subject matter include Chimassorb® 119; Chimassorb® 944; Chimassorb® 2020; Cyasorb® UV-3346; Cyasorb® UV-3529; Hostavin® N30 Formulation P; Tinuvin® 111; Tinuvin® 123; Tinuvin® 622; Tinuvin® 770, Tinuvin® 783, Uvasil® 299, Uvasorb® HA88 and Uvinul® 5050H. Irgafos®, Irgastab®, Tinuvin® and Chimassorb® are trademarks of Ciba Specialty Chemicals Corporation. Cyasorb® is a trademark of Cytec Corporation. Hostavin® and Sanduvor® are trademarks of Clariant Corporation of Coventry, R.I. Uvinul® is a trademark of BASF. Uvasil® is a trademark of Enichem of Houston, Tex. Uvasorb® is a trademark of 3V Sigma SpA of Bergamo, Italy.

Other useful HALS include bis(1,2,2,6,6-pentamethyl-4-piperidinyl)-3,5-bis(1,1-dimethylethyl-4-hydroxyphenyl)methyl-butyl propanedioate; bis(2,2,6,6-tetramethyl-4-piperdinyl) decanedioate; 1-acetyl-4-(3-dodecyl-2,5-dioxo-1-pyrrolidinyl)-2,2,6,6-tetramethyl-piperidine; N-unsubstituted HALS compounds such as Sanduvor® 3051, 3052 and 3055; N-methylated HALS compounds such as Sanduvor® 3056. Other useful HALS include bis(2,2,6,6-tetramethyl-4-piperdinyl)decanedioate; and 1-acetyl-4-(3-dodecyl-2,5-dioxo-1-pyrrolidinyl)-2,2,6,6-tetramethyl-piperidine.

When needed, UV blocking agents, also called UV absorbers, and free radical scavengers can be added to the top layer to improve the outdoor durability. UV absorbers suitable for this application are typically benzotriazole- or benzophenone-based compounds, or other compounds capable of absorbing UV energy in the required region. Commercially available UV absorbers include, without limitation, AMPACET 404276 and AMPACET 10561; TINUVIN 400 DW, TINUVIN 292 from BASF, Ludwigshafen, Germany; and HOSTAVIN 3310 from Clariant; Muttenz, Switzerland. The amount of HALS or UV absorber can range from about 0% to about 5%, preferably 1-5 wt %; alternately 1.5-2.5 wt %; alternately 1-3 wt %; alternately 2-3 wt %; alternately 0-3 wt %; alternately 0-1.5 wt %; alternately 0.5-1.5 wt %.

Typically for indoor applications, no UV stabilizer is used (0%). For outdoor applications, 2% UV stabilizer is used.

Free radical scavengers may also be added to the top layer of the film to improve the weather durability of the top layer. Suitable free radical scavengers include but are not limited to TINUVIN 1130, TINUVIN 123 DW from BASF, Ludwigshafen, Germany; and HOSTAVIN 3065 from Clariant, Muttenz, Switzerland. The amount of free radical scavengers can range from about 0% to about 5%.

Blocking is the adhesion or bonding of two surfaces of film that occurs after production and/or during prolonged storage. Layers of polymer film tend to stick together. The blocking phenomenon can be especially severe with polyolefin films like polyethylene and atactic or low molecular weight polypropylene. Antiblocking agents provide a micro-rough surface to a film resulting in less contact between layers/films. Suitable antiblocking agents herein include AMPACET 401960; AMPACET 401963; A. Schulman AB-5; and SYLOBLOC products. Antiblock agents are used in the compositions of the subject matter in amounts of up to 2 wt %, preferably 0.1-2 wt %, more preferably 0.1-1.5 wt %, still more preferably 0.5-1.5 wt %, even more preferably 0.5-1 wt %.

Flame retardant additives may be used. Useful flame retardant additives include bayerite aluminum hydroxide, gibbsite aluminum hydroxide, boehmite, magnesium hydroxide, phosphorus or organophosphorus compounds, melamine cyanurate, antimony oxide; and/or halogenated organic compounds such as dipentaerithritol, tetrabromobisphenol A carbonate oligomer, brominated polystyrene, melamine cyanurate, brominated phenoxy polymers, dioctyl tetra bromo terephthalate, decabromodiphenyloxide, tetrabromobisphenol A, brominated polymeric epoxy, polydibromophenylene oxide, and others. Commercially available examples of flame retardant additives include Polyfil FRC-2005PP. Flame retardants may be used in an amount of up to 5 wt %, alternately 0.1-5 wt %, alternately 0.5-3 wt %, alternately 1-2.5 wt %.

Slip additives are added to reduce the surface coefficient of friction of polymers and are used to enhance either processing or end applications. High and low level slip additives are available and immediate and slow acting performance can be engineered into the masterbatch. Useful slip additives herein include Sper-6 and Sper-6-SC from A. Schulman Co.

These films can be made by either cast or blown film technologies. Extrusion lines should have at least 3 extruders (more, if more distinct layers in the film are needed for performance). For cast technology, extruders' throughput and feedblock layer distribution should provide 10:80:10 (top:core:adhesive) layers for 3-layer film or 10:10:70:10 (top:tie:core:adhesive) for 4-layer film or 10:10:60:10:10 (top:tie:core:tie{functional layer}:adhesive) for 5-layer film. High gloss films can undergo in-line or off-line machine-direction or biaxial orientation for stiffness, improved handling and better gloss.

The films of the present subject matter can be used in operative association with a graphic or other message. As used herein, operative association typically includes applying the films over the graphic or message. The films of the subject matter may be applied to a previously printed print film to protect the indicia thereon.

The films can be used to protect a printable media for indoor and outdoor applications, architectural and transportation type advertising campaigns and the like. The films can also be used as a protective film to be laminated over a subject, such as a protective laminate for electronic appliances, architectural, artistic or aesthetic elements, a retro-reflective license plate, a retro-reflective signage film, a name plate, a label, automotive exterior and interior parts, and the like. Additional uses may include safety signs, graphic displays, governmentally mandated displays, military applications or surfaces that need protection in the outdoor environment.

In certain applications, the films also includes an adhesive layer or skin. The adhesive skin is optically transparent, and when used to contact the printed indicia, does not affect the printed indicia. The adhesive may be pattern coated, and may be selected for particular properties such as permanent, removable or repositionable and the like. The adhesive can include random copolymer adhesives or block copolymer adhesives. Random copolymer adhesives include those based upon acrylic and/or methacrylic copolymers, α-olefin copolymers, silicone copolymers, chloroprene/acrylonitrile copolymers, and the like. Block copolymer adhesives including those based upon linear block copolymers (i.e., A-B and A-B-A type), branched block copolymers, star block copolymers, grafted or radial block copolymers, and the like, and natural and synthetic rubber adhesives. A description of useful pressure sensitive adhesives can be found in Encyclopedia of Polymer Science and Engineering, Vol. 13. Wiley-Interscience Publishers (New York, 1988). Additional descriptions of useful pressure sensitive adhesives can be found in Encyclopedia of Polymer Science and Technology, Vol. 1, Interscience Publishers (New York, 1964). In many of the embodiments of the present subject matter, the adhesive includes a PP/PE RCP and particularly 3.2-5.5% ethylene PP/PE RCP. In certain versions, the ethylene PP/PE RCP has a MFR of 5-12.

When pressure sensitive adhesives are used, a release liner can be used to protect the adhesive from inadvertent contact with unintended surfaces. Any release liner suitable for the chosen adhesive can be used. For pressure sensitive adhesives, release liners can be coated papers or films, and super calendared paper, for example. Coating materials suitable for release liners include, for example, silicone-based and fluorine-based materials, or any other material that has the desired releasing properties, for example, waxes and carbamates.

Additional components, such as thickeners, flow and leveling agents, and rheology modifiers can be added to each of the top, middle, and bottom formulations or layers alternatively called skins, tie layers, core layers, outer layers, adhesive layers, or skin layers to achieve desired coating quality. Examples of suitable thickeners include, without limitation, ACRYSOL RM-2020 NPR, TM8W, and UCAR POLYPHOBE 115 TR from Dow Chemicals, Midland, Mich. Examples of suitable flow and leveling agents include without limitation, ZONYL FS300 from Dupont; Polyfox PF-156A from Omnova Solutions; and Masurf from Mason Chemical Company and others with similar chemistry. The percent incorporation can vary from 0% to 10% in both layers. Additional viscosity modifiers can be included in the formulation to modify the viscosity to a desired level and/or to impart desirable flow characteristics. These can be urethane based alkali swellable associative thickeners. Products like UCAR polyphobe 102 from Arkema Emulsion Systems or Rheolate 350 from Elementis are typical examples that can be used in the formulations. The percent incorporation of such additives can vary from between 0% to 10% in both layers.

When cross-linking is desirable, cross-linking agents can be added to the top layer formulations to improve the mechanical properties of that film layer. Examples of suitable cross-linking agents include, without limitation, polyaziridine based CX-100 from DSM Neo Resins, Waalwijk, The Netherlands; UCARLINK XL-25SE, ERL-4221, ERL-4234 from Dow Chemicals, Midland, Mich.; and COATOSIL 1770, SILQUEST A-187 from Momentive Performance Materials Inc., Waterford, N.Y.

Without limitation, other additives, for example, surfactants, defoamers, wetting agents, and known to those skilled in the art can be added to the composition of each of the top layer and bottom layer.

TABLE 5
Exemplary Formulation DOL 1.

| | | | | Matte- | Matte-A. | |
|---|---|---|---|---|---|---|
| | Manufact. # | Chemistry | MFR/MI | Ampacet | Schulman | Gloss |
| Top layer | FHR P4G3Z-050F | HPP | 4.2 MFR | 50 | | |
| | FHR 43S2A Lgv | PP/PE (3.2%) RCP | 1.9 MFR | | | 100 |
| | Ampacet 400700-D | Matif 97 | 3.0 MFR | 50 | | |
| | A. Schulman DUL3636D | Gloss modifier | 4.5 MFR | | 50 | |
| | A. Schulman SPER6SC | Erucamide in RCP | 11 MFR | | | 1.0 |

| | Ampacet 10919 | PA in LDPE | 2.0 MI | 0.5 | |
|---|---|---|---|---|---|
| | Ampacet 10561 | UV in LDPE | 9.0 MI | 2.5 | |
| | Ampacet 401960 | AB in RCP | 9.0 MFR | | 0.5 |
| Core | FHR 43S2A Lgv | PP/PE (3.2%) RCP | 1.9 MFR | 100 | |
| | Ampacet 10561 | UV in LDPE | 9.0 MI | 2.5 | |
| Adhesive | FHR 43S2A Lgv | PP/PE (3.2%) RCP | 1.9 MFR | 85 | |
| skin | Ateva 1821A | EVA (18% VA) | 3.0 MI | 15 | 10 |
| | Dow DS6D81 | PP/PE (5.5%) RCP | 5.0 MFR | | 90 |
| | Ampacet 10919 | PA in LDPE | 2.0 MI | 0.5 | |
| | A.Schulman AB-5 | AB in LDPE | 17 MI | 1.0 | |
| | Ampacet 401960 | AB in RCP | 9.0 MFR | | 1.0 |

TABLE 6
Testing Results for Formulation DOL 1.

| | | | | | |
|---|---|---|---|---|---|
| | Tensile | | | Tensile | |
| Modulus- | Strength- | | Modulus- | Strength- | |
| MD | MD | Elongation- | CD | CD | Elongation- |

| | psi | MPa | psi | MPa | MD, % | psi | MPa | psi | MPa | CD, % |
|---|---|---|---|---|---|---|---|---|---|---|
| Matte- | 120,710 | 832 | 5,180 | 36 | 615 | 66,479 | 458 | 3,618 | 25 | 1,255 |
| Ampacet | | | | | | | | | | |
| Matte-A. | 126,002 | 869 | 4,612 | 32 | 562 | 89,324 | 616 | 3,791 | 26 | 966 |
| Schulman | | | | | | | | | | |
| Gloss | 126,973 | 875 | 5,271 | 36 | 538 | 74,431 | 513 | 3,936 | 27 | 849 |

| | | | |
|---|---|---|---|
| | Tear | | |
| Stiffness, | resistance, | Shrink, % | Gloss, |
| mN | gf/mil | (70° C./24 h) | 60° |

| | MD | CD | MD | CD | MD | CD | MD | CD | Haze |
|---|---|---|---|---|---|---|---|---|---|
| Matte- | 29 | 34 | 20 | 83 | −0.1 | 0.9 | 13 | 16 | |
| Ampacet | | | | | | | | | |
| Matte-A. | 29 | 24 | 19 | 83 | 0.0 | 0.1 | 14 | 16 | |
| Schulman | | | | | | | | | |
| Gloss | 20 | 20 | 17 | 85 | 0.3 | 0.1 | 5 | 93 | 10 |

| COF | | | |
|---|---|---|---|
| | Print/ | Non-print/ | |
| Print/ | Stainless | Stainless | |
| non-print | Steel | Steel | Caliper |

| | Static | Kinetic | Static | Kinetic | Static | Kinetic | mil | microns |
|---|---|---|---|---|---|---|---|---|
| Matte- | 0.4 | 0.4 | 0.2 | 0.2 | 0.2 | 0.2 | 2.58 | 65.6 |
| Ampacet | | | | | | | | |
| Matte-A. | 0.5 | 0.5 | 0.2 | 0.2 | 0.2 | 0.2 | 2.44 | 62.1 |
| Schulman | | | | | | | | |
| Gloss | 0.4 | 0.5 | 0.2 | 0.2 | 0.2 | 0.2 | 2.28 | 57.9 |

TABLE 7
Exemplary Formulation DOL 2.

| | Supplier # | Chemistry | MFR/MI | Gloss |
|---|---|---|---|---|
| Adhesive | FHR 43S2A | PP/PE RCP 3.2% PE | 1.9 MFR | 90 |
| skin | Celanese 1821A | EVA (18% VA) | 3.0 MI | 10 |
| | Ampacet 401960 | AB in RCP | 9.0 MFR | 1.0 |
| Core | FHR 43S2A | PP/PE RCP 3.2% PE | 1.9 MFR | 15 |
| | Dowlex 2247 | LLDPE | 2.3 MI | 85 |
| | Ampacet 10561 | UV in LDPE | 9.0 MI | 2.0 |
| Top skin | FHR 43S2A | PP/PE RCP 3.2% PE | 1.9 MFR | 100 |
| | Ampacet 10561 | UV in LDPE | 9.0 MI | 2.5 |
| | Ampacet 401960 | AB in RCP | 9.0 MFR | 0.5 |

TABLE 8
Test Results for Formulation DOL 2.

| | | | Tensile | | | | | Tensile | | | |
|---|---|---|---|---|---|---|---|---|---|---|---|
| | Modulus- | | Strength- | | | Modulus- | | Strength- | | | |
| | MD | | MD | | Elongation- | CD | | CD | | Elongation- | |
| | psi | MPa | psi | MPa | MD, % | Psi | MPa | psi | MPa | CD, % | Haze |
| Gloss | 59,778 | 412 | 11,799 | 81 | 129 | 41,046 | 283 | 2,862 | 20 | 958 | 8.6 |

| | | | | |
|---|---|---|---|---|
| Tear | | | | |
| resistance, | Stiffness, | Gloss, | % Shrink, % | |
| gf/mil | mN | 60° | (70° C./24 h) | Caliper |

| | MD | CD | MD | CD | MD | CD | MD | CD | mil | μm |
|---|---|---|---|---|---|---|---|---|---|---|
| Gloss | 56 | 744 | 14 | 15 | 90 | 70 | 0.8 | 0.6 | 2.40 | 61.0 |

| | | | | | COF | | | | | |
|---|---|---|---|---|---|---|---|---|---|---|
| | | | | | | | Print- | | Non/print- | |
| | Curl, 32nd in | | | | Print- | | stainless | | stainless | |
| | Print | | Adhesive | | non/print | | steel | | steel | |
| | MD | CD | MD | CD | Static | Kinetic | Static | Kinetic | Static | Kinetic |
| Gloss | 0.0 | 0.0 | 0.0 | 0.0 | 0.4 | 0.5 | 0.2 | 0.2 | 0.3 | 0.2 |

Various ranges and/or values of melt flow index (MFI) or melt flow rate (MFR) are noted herein. Melt flow index is typically measured as described in ASTM D1238 and ISO 1133. Melt flow index is sometimes referred to as melt index (MI). Typically, the melt flow index (MFI) is determined at conditions of 230° C. and 2.16 Kg as noted in the referenced test method standards.

Tear Resistance was determined by a Thwing Albert Elmendorf Tester, ASTM D1922. All samples have excellent tear resistance. Values below 10 gf/mil may result in film splittiness problems at application.

Haze and Clarity are determined on a BYK Gardner Haze-Gard Plus, in accordance with ASTM D1003. Cast films have less haze as compared to blown ones. Usually haze values below 15 are acceptable, while below 10 are preferred.

Thickness. Film thickness is measured using Emveco Electronic Microgage 210A, in accordance with ASTM D5947. The specimen is placed between an upper and a lower anvil. The upper anvil rests on top of the specimen and the thickness is measured and displayed on the digital readout.

Accelerated Weathering. The accelerated weathering test simulates the damaging effects of long term outdoor exposure of materials by exposing test samples to light, moisture and temperature extremes. Sample is tested and observed for light fastness (fading of colors), and weatherability (cracking, chalking, curling, shrinkage, etc. . . . ). An Atlas C165A Xenon Arc Weather-Ometer from Atlas Material Testing Technology LLC in Chicago, Ill. is used for this test.

The coefficient of friction was measured using a Thwing-Albert Friction/Peel Tester model 255-1 V2.1 according to ASTM D1894, ASTM D4521 and TAPP1-T816.

Gloss. Gloss is measured using a Hunter Lab ProGloss 60° in accordance with ASTM D2457. The universal measurement angle 60° is used for the measurement. Typically the acceptable gloss reading is 80 or higher. Low gloss films have gloss reading below 20, preferably below 10.

Shrinkage Test. Test sample is coated with a pressure sensitive adhesive under the trade name 5652 from Avery Dennison Corporation in Pasadena, Calif. at about 30 gram per square meter (gsm) coat weight. The sample is then attached to a clean aluminum panel from O-Lab Corporation of Cleveland, Ohio. The sample is dwelled at ambient condition for 24 hours. A 5 inch (127 mm) cross hatch in both machine direction (MD) and cross-machine direction (CD) are made on the film. The sample is then aged at 160° F. (71° C.) for 24 hours. The dimension change in the MD and CD are measured. If the shrinkage is less than 0.33% in both directions, the sample is given a pass grade.

Publications, patents, standards, and patent applications are referred to throughout this disclosure. All are hereby incorporated by reference.

All of the features disclosed in the specification, including the claims, abstract, and drawings, and all of the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise. Thus, unless expressly stated otherwise, each feature disclosed is one example only of a generic series of equivalent or similar features.

The foregoing detailed description of the present subject matter is provided for purposes of illustration, and it is not intended to be exhaustive or to limit the subject matter to the particular embodiments disclosed. The embodiments may provide different capabilities and benefits, depending on the configuration used to implement the key features of the subject matter. Accordingly, the scope of the subject matter is defined only by the following claims.

What is claimed is:

1. An optically transparent protective film comprising:
a) a top layer,
b) middle layer, substantially coextensive with, and adhered to, the top layer, and
c) a bottom layer, substantially coextensive with, and adhered to, the middle layer,
wherein the top layer includes a polypropylene homopolymer or copolymer.

2. The film of claim 1, wherein at least one of the top, middle, and bottom layers includes at least one additive.

3. The film of claim 2, wherein the at least one additive is selected from the group consisting of slip agents, antiblock agents, flame retardants, process aids, free-radical scavengers, cross-linking agents, thickeners, flow and leveling agents, rheology modifiers, surfactants, defoamers, wetting agents, and combinations thereof.

4. A glossy optically transparent protective film comprising:
a) a skin layer comprising:
i) an abrasion resistant resin having a MFR of 4.2-12 and a MI of 0.1 to 12, and
ii) at least one additive selected from the group consisting of process aids and antiblock agents,
b) at least one tie layer comprising:
i) ethylene vinyl acetate having a MI of 0.1-10, and
ii) 0 to 5 wt % UV stabilizer,
c) a core layer comprising:
i) 3.2-5.5% polyethylene PP/PE RCP having a MFR of 5-12,
ii) 0 to 5 wt % UV stabilizer, and
d) an adhesive layer comprising:
i) 3.2 to 5.5% ethylene PP/PE RCP having a MFR of 5-12,
ii) 0 to 5% UV stabilizer,
iii) 0.1-2% antiblock agent, and
iv) 0 to 1% of a process aid.

5. The film of claim 4, wherein the skin, tie, core, and adhesive layers are present in a weight ratio of 5-15 wt %:5-15 wt %:55-85 wt %:5-15 wt %, respectively.

6. A multilayer film comprising (i) an outer layer or skin layer which includes an abrasion resistant resin, (ii) a core layer which includes at least one of polyethylene PP/PE RCP and HPP, and (iii) an adhesive layer which includes ethylene PP/PE RCP.

7. The film of claim 6 wherein the film is a matte optically transparent protective film comprising:
a) an outer layer comprising:
i) an abrasion resistant resin,
ii) a gloss modifier,
iii) at least one additive selected from the group consisting of process aids and antiblock agents,
b) a core layer comprising polyethylene PP/PE RCP,
c) an adhesive layer comprising:
i) 3.2-5.5% ethylene PP/PE RCP,
ii) a UV stabilizer,
iii) a process aid, and
iv) an antiblock agent.

8. The film of claim 7, wherein the outer, core and adhesive layers are present in a weight ratio of 5-15 wt %:70-90 wt %:5-15 wt %, respectively.

9. The film of claim 6 wherein the film is a glossy optically transparent protective film comprising:
a) a skin layer comprising:
i) an abrasion resistant resin,
ii) at least one additive selected from the group consisting of process aids and antiblock agents,
b) a tie layer comprising EVA,
c) a core layer comprising:
i) 3.2-5.5% ethylene PP/PE RCP, and
ii) a UV stabilizer, and
d) an adhesive layer comprising:
i) 3.2-5.5% ethylene PP/PE RCP,
ii) 5-15 wt % EVA with 18-35 wt % vinyl acetate,
iii) a UV stabilizer,
iv) a process aid, and
v) an antiblock agent.

10. The film of claim 9, wherein the skin, tie, core and adhesive layers are present in a weight ratio of 5-15 wt %:5-15 wt %:55-85 wt %:5-15 wt %, respectively.

11. The film of claim 6 wherein the film is a glossy optically transparent protective film comprising:
a) an outer layer comprising:
i) an abrasion resistant resin,
ii) at least one additive selected from the group consisting of process aids and antiblock agents,
b) a core layer comprising:
i) 3.2-5.5% ethylene PP/PE RCP, and
c) an adhesive layer comprising:
i) 3.2-5.5% ethylene PP/PE RCP,
ii) a UV stabilizer,
iii) an antiblock agent, and
iv) a process aid.

12. The film of claim 11, wherein the outer, core and adhesive layers are present in a weight ratio of 5-15 wt %:70-90 wt %:5-15 wt %, respectively.

13. The film of claim 6 wherein the film is a matte optically transparent protective film comprising:
a) an outer layer comprising:
i) an abrasion resistant resin,
ii) a gloss modifier, and
iii) a process aid,
b) a core layer comprising HPP, and
c) an adhesive layer comprising:
i) 3.2-5.5% ethylene PP/PE RCP,
ii) a UV stabilizer,
iii) a process aid, and
iv) an antiblock agent.

14. The film of claim 13, wherein the outer, core and adhesive layers are present in a weight ratio of 5-15 wt %:70-90 wt %:5-15 wt %, respectively.

15. A vinyl-free optically transparent protective film comprising:
a) a top layer comprising:
i) 50-100 wt % of a HPP or a PP/PE RCP,
ii) 0-50 wt % of a gloss modifier,
iii) 0-10 wt % of a slip agent,
iv) 0.1-2 wt % of an antiblock agent, and
v) 0.1-1.5 wt % of a flame retardant,
the amounts of (iii)-(v) based on 100% total of (i)+(ii);
b) a middle layer, substantially coextensive with, and adhered to, the top layer, comprising:
i) 90-100 wt % linear low density polyethylene (LLDPE),
ii) 0-10 wt % of a second component selected from the group consisting of LLDPE, LDPE, PP/PE RCP, HPP, EVA, and combinations thereof, and
iii) 0.1-1 wt % of flame retardant,
the amounts of (iii) based on 100% total of (i)+(ii);
c) a bottom layer, substantially coextensive with, and adhered to, the middle layer, comprising:
i) 85-97 wt % of at least one agent selected from the group consisting of HPP, PP/PE RCP, LLDPE and LDPE,
ii) 3-15 wt % of EVA with 18-35 wt % vinyl acetate,
iii) 0.1-1.5 wt % of an antiblock agent, and
iv) 0.1-1 wt % flame retardant additive,
the amounts of (iii)-(iv) based on 100% total of (i)+(ii).

16. The film of claim 15, wherein the top, middle and bottom layers have a weight ratio of 5-25/50-90/5-25, respectively.

17. The film of claim 15, wherein the top, middle and bottom layers all substantially lack PVC.

18. The film of claim 15, wherein the HPP or PP/PE RCP is nucleated.

19. A multilayer film assembly comprising:
a) a polymeric top layer,
b) middle layer adjacent to and in contact with the top layer, and
c) a bottom layer comprising a polyethylene PP/PE RCP.

20. The film of claim 19, wherein
a) the top layer comprises:
i) 95-100 wt % HPP,
ii) 0-5 wt % of a slip agent,
iii) 0.5-1.5 wt % antiblock agent, and
iv) 0.1-1 wt % flame retardant,
the amounts of (iii)-(iv) based on 100% total of (i)+(ii).
b) the middle layer comprises:
i) 95-100 wt % LLDPE,
ii) 0-5 wt % of at least one agent selected from the group consisting of LDPE, PE PE/PP RCP, HPP, EVA, and combinations thereof, and
iii) 0.1-1 wt % of a flame retardant,
the amounts of (iii) based on 100% total of (i)+(ii), and
c) the bottom layer comprises:
i) 85-95 wt % of PE PE/PP RCP,
ii) 5-15 wt % of EVA copolymer having 18-35 wt % vinyl acetate content and a MFI of 2-4.
iii) 0.5-1.5 wt % of an antiblock agent, and
iv) 0.1-1 wt % flame retardant,
the amounts of (iii)-(iv) based on 100% total of (i)+(ii).

21. The film of claim 19, wherein
a) the top layer comprises:
i) 90-100 wt % of 3-6% polyethylene PP/PE RCP with a MFI (230° C./2.16 kg) of 1-10,
ii) 0.1-10 wt % of a slip agent,
iii) 0.5-1.5 wt % antiblock agent, and
iv) 0.1-1 wt % process aid,
the amounts of (iii)-(iv) based on 100% total of (i)+(ii),
b) the middle layer comprises:
i) 95-99.9 wt % of 3-6% polyethylene PP/PE RCP with a MFI (230° C./2.16 kg) of 1-10,
ii) 0.1-5 wt % of at least one agent selected from the group consisting of HPP, RCP, LLDPE, LDPE, EVA and combinations thereof, and
c) the bottom layer comprises:
i) 80-90 wt % of 3-6% polyethylene PP/PE RCP with a MFI (230° C./2.16 kg) of 1-10,
ii) 10-20 wt % of EVA copolymer having 18-35% vinyl acetate content and an MFI of 2-4,
iii) 0.5-1.5 wt % of an antiblock agent, and
iv) 0.1-1 wt % of a process aid,
the amounts of (iii)-(iv) based on 100% total of (i)+(ii).

22. The film of claim 19, wherein
a) the top layer comprises:
i) 95-100 wt % of 3-6% polyethylene PP/PE RCP with a MFI (230° C./2.16 kg) of 1-10,
ii) 0-5 wt % a slip agent,
iii) 0.5-1.5 wt % antiblock agent, and
iv) 0.1-1 wt % process aid,
the amounts of (iii)-(iv) based on 100% total of (i)+(ii);
b) the middle layer comprises:
i) 95-100 wt % of 3-6% polyethylene PP/PE RCP with a MFI (230° C./2.16 kg) of 1-10,
ii) 0-5 wt % of at least one agent selected from the group consisting of HPP, LLDPE, LDPE, and EVA, and combinations thereof,
iii) 0.5-1.5 wt % of a UV additive, and
the amount of (iii) based on 100% total of (i)+(ii), and
c) the bottom layer comprises:
i) 80-90 wt % of 3.2% polyethylene PP/PE RCP with a MFI (230° C./2.16 kg) of 1-10,
ii) 10-20 wt % of EVA copolymer having 18-35% vinyl acetate content and an MFI of 2-4.
iii) 0-1.5 wt % of a UV additive,
iv) 0.5-1.5 wt % of an antiblock agent, and
v) 0.1-1 wt % of a process aid,
the amounts of (iii)-(v) based on 100% total of (i)+(ii).

23. The film of claim 19, wherein
a) the top layer comprises:
i) 40-60 wt % of polypropylene having a MFI (230° C./2.16 kg) of 3-12,
ii) 60-40 wt % of gloss modifier having a MFI (230° C./2.16 kg) of 2-4, and
iii) 0.1-1 wt % process aid,
the amounts of (iii) based on 100% total of (i)+(ii);
b) the middle layer comprises:
i) 95-99.9 wt % of 3.2% polyethylene PP/PE RCP with a MFI (230° C./2.16 kg) of 1-10,
ii) 0.1-5 wt % of at least one agent selected from the group consisting of LDPE, LLDPE, HPP, and EVA, and
c) the bottom layer comprises:
i) 80-90 wt % of 3.2% polyethylene PP/PE RCP with a MFI (230° C./2.16 kg) of 1-10,
ii) 10-20 wt % of EVA copolymer having 18-35% vinyl acetate content and an MFI of 2-4,
iii) 0.5-1.5 wt % of an antiblock agent, and
iv) 0.1-1 wt % of a process aid,
the amounts of (iii)-(iv) based on 100% total of (i)+(ii).

24. The film of claim 19, wherein
a) the top layer comprises:
i) 40-60 wt % of polypropylene having a MFI (230° C./2.16 kg) of 3-12,
ii) 60-40 wt % of gloss modifier having a MFI (230° C./2.16 kg) of 2-4, and
iii) 0.1-1 wt % process aid,
the amounts of (iii) based on 100% total of (i)+(ii);
b) the middle layer comprises:
i) 40-60 wt % of 3.2% polyethylene PP/PE RCP with a MFI (230° C./2.16 kg) of 1-10,
ii) 60-40 wt % of a component selected from the group consisting of PP, LDPE, EVA, and combinations thereof,
c) the bottom layer comprises:
i) 80-90 wt % of 3.2% polyethylene PP/PE RCP with a MFI (230° C./2.16 kg) of 1-10,
ii) 10-20 wt % of EVA copolymer having 18-35% vinyl acetate content and an MFI of 2-4,
iii) 0-1.5 wt % of a UV additive,
iv) 0.5-1 wt % of an antiblock agent, and
v) 0.1-1 wt % of a process aid,
the amounts of (iii)-(v) based on 100% total of (i)+(ii).

25. An optically transparent protective film comprising:
a) a top layer comprising:
i) 50-100 wt % of a HPP or a PP/PE RCP,
ii) 0-50 wt % of a gloss modifier,
iii) 0-10 wt % of a slip agent,
iv) 0.1-2 wt % of an antiblock agent, and
v) 0.1-1.5 wt % of a flame retardant,
the amounts of (iii)-(v) based on 100% total of (i)+(ii);
b) a middle layer, substantially coextensive with, and adhered to, the top layer, comprising:
i) 90-100 wt % of a first resin selected from the group consisting of LLDPE, PP/PE RCP, HPP, EVA, and combinations thereof,
ii) 0-10 wt % of a second resin, different from the first resin, selected from the group consisting of LLDPE, LDPE, PP/PE RCP, HPP, EVA, and combinations thereof,
iii) 0.1-1 wt % of flame retardant,
the amounts of (iii) based on 100% total of (i)+(ii);
c) a bottom layer, substantially coextensive with, and adhered to, the middle layer, comprising:
i) 85-99.9 wt % of at least one agent selected from the group consisting of HPP, PP/PE RCP, LLDPE, LDPE, and combinations thereof,
ii) 0.1-15 wt % of EVA with 18-35 wt % vinyl acetate,
iii) 0.1-1.5 wt % of an antiblock agent, and
iv) 0.1-1 wt % flame retardant additive,
the amounts of (iii)-(iv) based on 100% total of (i)+(ii).

26. The film of claim 25, wherein the top layer HPP or PP/PE RCP has a MFI (230° C./2.16 kg) of 4-15 and wherein the top layer gloss modifier has a MFI (230° C./2.16 kg) of 2.5.

27. A protective film comprising:
a) a top layer comprising:
i) 80-100 wt % of HPP or PP/PE RCP,
ii) 0-20 wt % of gloss modifier,
iii) 1-5 wt % of a slip agent,
iv) 0.1-1 wt % antiblock agent, and
v) 0.1-1 wt % flame retardant,
the amounts of (iii)-(v) based on 100% total of (i)-(ii);
b) a middle layer comprising:
i) 95-100 wt % of a first resin selected from the group consisting of LLDPE, PP/PE RCP, and combinations thereof,
ii) 0-5 wt % of the second resin, different from the first resin, selected from the group consisting of LLDPE, LDPE, PP/PE RCP, HPP, EVA, and combinations thereof, and
iii) 0.1-1 wt % of flame retardant,
the amount of (iii) based on 100% total of (i)+(ii), and
c) a bottom layer comprising:
i) 85-99.9 wt % of the at least one first resin,
ii) 0.1-15 wt % of EVA copolymer,
iii) 0.5-1.5 wt % of an antiblock agent, and
iv) 0.1-1 wt % of flame retardant,
the amounts of (iii)-(iv) based on 100% total of (i)+(ii).

28. The film of claim 27, wherein the top layer HPP or PP/PE RCP has a MFI (230° C./2.16 kg) of 4-15 and wherein the top layer gloss modifier has a MFI (230° C./2.16 kg) of 2-5.
